(19) United States
(12) Patent Application Publication
(10) Pub. No.: US 2026/0348875 A1
(43) Pub. Date: Nov. 5, 2026

(54) TUNABLE LASER SOURCE INTERFEROMETRY FOR SEMICONDUCTOR PACKAGING METROLOGY

(71) Applicant: KLA Corporation, Milpitas, CA (US)

(72) Inventor: Qiang Zhao, Milpitas, CA (US)

(21) Appl. No.: 19/664,022

(22) Filed: Apr. 30, 2026

Related U.S. Application Data
(60) Provisional application No. 63/799,817, filed on May 5, 2025.

(51) Int. Cl. G01N 21/95; G01N 21/45

(52) U.S. Cl. CPC G01N 21/9505; G01N 21/45; G01N 2201/06113

(57) ABSTRACT

An interferometric measurement system may include a tunable laser source configured to emit laser light in an infrared spectral range across a wavelength range comprising a plurality of discrete wavelengths and scan across the wavelength range. The system may include an interferometer having a sample path and a reference path, wherein the laser light in the sample path interacts with a sample. A detector may capture interference signals resulting from combination of the laser light returned from the reference path and the sample path as the tunable laser source scans across the wavelength range. A controller having one or more processors may determine a variation of the interference signals as a function of wavelength, extract an optical path difference between the reference path and the sample path based on the variation, and generate metrology measurements of the sample based on the extracted optical path difference.

### CROSS-REFERENCE TO RELATED APPLICATIONS

The present application claims the benefit under 35 U.S.C. § 119(e) of U.S. Provisional Application No. 63/799,817, filed May 5, 2025, which is incorporated herein by reference in the entirety.

### TECHNICAL FIELD

The present disclosure relates generally to interferometric measurement systems and, more particularly, to wavelength-tunable interferometry for process monitoring and control in semiconductor packaging.

### BACKGROUND

Semiconductor packaging technologies continue to evolve toward increasingly complex architectures, including three-dimensional stacking, heterogeneous integration, and wafer-level packaging. These advanced packaging approaches incorporate multiple semiconductor dies, intricate interconnect structures, and diverse materials, resulting in features with large dimensional ranges and tight process tolerances. Accurate metrology and inspection of such features are important for maintaining manufacturing yield and device reliability. Conventional measurement techniques may face limitations when measuring features with large vertical dimensions or when operating through thick substrates, as the coherence length of traditional light sources may be insufficient to maintain interference over the required optical path differences. For example, conventional laser sources such as helium-neon (HeNe) lasers, neodymium-doped yttrium aluminum garnet (Nd:YAG) lasers, and titanium-sapphire (Ti:Sapphire) lasers may have coherence lengths that limit their applicability for large-feature measurement in advanced packaging applications. There is therefore a need to develop systems and methods to address the above deficiencies.

### SUMMARY

In embodiments, an interferometric measurement system is provided. The interferometric measurement system may include a tunable laser source configured to emit laser light in an infrared spectral range across a wavelength range that includes a plurality of discrete wavelengths. The tunable laser source may be configured to scan across the wavelength range. The interferometric measurement system may include an interferometer having a sample path and a reference path, where the laser light in the sample path interacts with a sample. The interferometric measurement system may include a detector configured to capture interference signals resulting from combination of the laser light returned from the reference path and the sample path as the tunable laser source scans across the wavelength range. The interferometric measurement system may include a controller having one or more processors configured to execute program instructions causing the one or more processors to determine a variation of the interference signals as a function of wavelength across the scan, extract an optical path difference between the reference path and the sample path based on the variation, and generate one or more metrology measurements of the sample based on the extracted optical path difference.

In embodiments, the one or more processors may be configured to extract the optical path difference by analyzing a frequency of oscillation of the interference signals as a function of wavelength across the scan.

In embodiments, the one or more processors may be further configured to apply a model to the interference signals to extract signals associated with a target feature of the sample and filter signals associated with other structures of the sample, where the model is based on an expected structure of the sample.

In embodiments, the model may be based on at least one of: design information associated with the sample, or other metrology measurements of the sample.

In embodiments, the model may include a machine learning model trained on labeled interference signal data with known target feature locations and known non-target structure locations.

In embodiments, the wavelength range may extend from approximately 1250 nm to approximately 1650 nm.

In embodiments, the tunable laser source may have an instantaneous spectral linewidth of less than 500 MHz at each wavelength within the wavelength range.

In embodiments, the plurality of discrete wavelengths may have a wavelength spacing of 0.0001 nm or smaller.

In embodiments, the one or more processors may be further configured to provide a feedback signal to adjust a manufacturing process based on the metrology measurements.

In embodiments, the interferometer may include one of: a Michelson interferometer, a Fizeau interferometer, a Mirau interferometer, or a Linnik interferometer.

In embodiments, the detector may include a photodetector.

In embodiments, the detector may include a pixelated image sensor configured to capture a two-dimensional interference pattern as the tunable laser source scans across the wavelength range, and the one or more processors may be configured to extract, for each pixel of the pixelated image sensor, a respective optical path difference based on the variation of the interference signals at that pixel as a function of wavelength.

In embodiments, the sample path may be configured to direct laser light toward a backside of the sample for measurement of features through a substrate of the sample.

In embodiments, the metrology measurements may include at least one of: a bump height, a through-silicon via (TSV) depth, a remaining silicon thickness, a redistribution layer critical dimension, an under-bump metallization step height, a die or wafer bow or warpage, a dicing groove depth, or a substrate edge hump height or trim depth.

In embodiments, the metrology measurements may include detection of a defect within the sample based on a phase change or interferometric pattern change in the interference signals during the scan, and the defect may include at least one of: a crack within a die, a void within a die, a void at a bonding interface, or a defect in a TSV.

In embodiments, the sample may include a substrate formed from at least one of: silicon, glass, a ceramic material, alumina, aluminum nitride, FR-4, BT resin, or polyimide.

In embodiments, the coherence length may be sufficient to maintain interference of the laser light over an optical path difference of at least 1 millimeter.

In embodiments, an interferometric measurement system is provided. The interferometric measurement system may include an array of tunable laser sources, each tunable laser source configured to emit laser light in an infrared spectral range across a wavelength range that includes a plurality of discrete wavelengths and scan across the wavelength range. The array may be configured to simultaneously direct laser light toward a plurality of locations on a sample. The interferometric measurement system may include an interferometer having a beam splitter, a reference path, and a sample path. The interferometric measurement system may include a detector configured to capture interference signals at each of the plurality of locations as the array of tunable laser sources scans across the wavelength range, each interference signal resulting from combination of laser light returned from the reference path and the sample path. The interferometric measurement system may include a controller having one or more processors configured to determine, for each location, a variation of the interference signals as a function of wavelength across the scan, extract, for each location, an optical path difference between the reference path and the sample path based on the variation, and generate one or more metrology measurements of the sample at each of the plurality of locations based on the extracted optical path differences.

In embodiments, the one or more processors may be further configured to apply a model to the interference signals to extract signals associated with a target feature of the sample and filter signals associated with other structures of the sample.

In embodiments, the array of tunable laser sources may be arranged in a one-dimensional configuration.

In embodiments, the array of tunable laser sources may be arranged in a two-dimensional configuration.

In embodiments, the detector may include an array of photodetectors, each photodetector corresponding to a respective tunable laser source of the array.

In embodiments, the detector may include a pixelated image sensor, and the one or more processors may be configured to extract, for each pixel of the pixelated image sensor, a respective optical path difference based on the variation of the interference signals at that pixel as a function of wavelength.

In embodiments, the sample path may be configured to direct laser light toward a backside of the sample for measurement of features through a substrate of the sample.

In embodiments, the sample may include a semiconductor packaging structure.

In embodiments, a method for performing metrology measurements on a sample is provided. The method may include scanning a tunable laser source across a wavelength range in an infrared spectral range, the wavelength range including a plurality of discrete wavelengths. The method may include directing laser light from the tunable laser source through an interferometer to the sample, the interferometer having a beam splitter, a reference path, and a sample path. The method may include capturing interference signals resulting from combination of laser light returned from the reference path and the sample path as the tunable laser source scans across the wavelength range. The method may include determining a variation of the interference signals as a function of wavelength across the scan. The method may include extracting an optical path difference between the reference path and the sample path based on the variation. The method may include generating one or more metrology measurements of the sample based on the extracted optical path difference.

In embodiments, the method may further include applying a model to the interference signals to extract signals associated with a target sample attribute and filter signals associated with other structures of the sample, where the model is based on an expected structure of the sample.

In embodiments, the metrology measurements may include at least one of: a bump height, a TSV depth, a remaining silicon thickness, a redistribution layer critical dimension, an under-bump metallization step height, a die or wafer bow or warpage, a dicing groove depth, or a substrate edge hump height or trim depth.

In embodiments, the metrology measurements may include detection of a defect within the sample based on a phase change or interferometric pattern change in the interference signals during the scan.

In embodiments, the defect may include at least one of: a crack within a die, a void within a die, a void at a bonding interface, or a defect in a TSV.

In embodiments, the method may further include directing the laser light toward a backside of the sample for measurement of features through a substrate of the sample.

In embodiments, the tunable laser source may include an array of tunable laser sources arranged in a one-dimensional or two-dimensional configuration, and capturing the interference signals may include capturing interference signals at a plurality of locations on the sample in parallel.

In embodiments, the metrology measurements may include evaluation of a thermal property of the sample by monitoring a change in the interference signals resulting from a temperature change within the sample.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures in which:

FIG. 1A is a conceptual view of an interferometric measurement system for performing wavelength-swept interferometry, in accordance with one or more embodiments of the present disclosure.

FIG. 1B is a schematic view of an optical configuration of an interferometric measurement system arranged as a Michelson interferometer, in accordance with one or more embodiments of the present disclosure.

FIG. 1C is a schematic view of an optical configuration of an interferometric measurement system arranged as a Michelson interferometer with beam conditioning optics, in accordance with one or more embodiments of the present disclosure.

FIG. 1D is a schematic view of an optical configuration of an interferometric measurement system arranged as a Fizeau interferometer, in accordance with one or more embodiments of the present disclosure.

FIG. 1E is a schematic view of two configurations of an array of tunable laser sources, in accordance with one or more embodiments of the present disclosure.

FIG. 2 is a flow diagram of a method for performing metrology measurements on a sample, in accordance with one or more embodiments of the present disclosure.

FIG. 3A is a plot depicting a light source frequency sweep as a function of time, in accordance with one or more embodiments of the present disclosure.

FIG. 3B is a plot depicting interference patterns for a wavelength sweep corresponding to two different features of a sample, in accordance with one or more embodiments of the present disclosure.

FIG. 4 is a cross-sectional view of a sample depicting edge feature measurements, in accordance with one or more embodiments of the present disclosure.

FIG. 5 is a cross-sectional view of a sample depicting topside measurements in a semiconductor packaging process, in accordance with one or more embodiments of the present disclosure.

FIG. 6 is a cross-sectional view of a sample depicting backside measurements, in accordance with one or more embodiments of the present disclosure.

FIG. 7 is a cross-sectional view of a sample depicting through-sample backside measurements, in accordance with one or more embodiments of the present disclosure.

FIG. 8 is a cross-sectional view of a sample depicting defect detection, in accordance with one or more embodiments of the present disclosure.

FIG. 9 is a cross-sectional view of a sample depicting thermal-based measurements, in accordance with one or more embodiments of the present disclosure.

FIG. 10 is a cross-sectional view of a stacked semiconductor packaging architecture suitable for thermal inspection, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to systems and methods providing interferometric measurement using tunable laser sources for process monitoring and control in semiconductor packaging applications. In embodiments, an interferometric measurement system includes a tunable laser source configured to scan across a wavelength range in an infrared spectral range, an interferometer that directs the laser light along a sample path and a reference path, and a detector that captures interference signals as the tunable laser source scans. The tunable laser source may have a narrow instantaneous spectral linewidth providing a coherence length sufficient to maintain interference over optical path differences of at least one millimeter, enabling measurement of sample attributes on a surface of a sample, within a sample, or through a sample from a backside.

It is contemplated herein that advanced semiconductor packaging technologies, including three-dimensional stacking, heterogeneous integration, and wafer-level packaging, incorporate multiple semiconductor dies, complex interconnect structures, and diverse materials that present measurement challenges for conventional interferometric techniques. In some cases, features encountered in advanced packaging may have vertical dimensions ranging from a few micrometers to hundreds of micrometers, and measurement through substrates may require optical path differences exceeding one millimeter. Conventional interferometric systems employing broadband light sources or fixed-wavelength lasers may have limited coherence lengths that are insufficient to maintain interference over such large optical path differences. Additionally, conventional approaches may require mechanical scanning of reference elements to acquire depth information, which can limit measurement throughput. The wavelength-swept interferometry approach disclosed herein addresses these considerations by employing tunable laser sources with narrow instantaneous spectral linewidths that provide extended coherence lengths while enabling depth extraction through analysis of interference signal variations as a function of wavelength rather than mechanical scanning.

In embodiments, an interferometric measurement system includes a tunable laser source configured to emit laser light in an infrared spectral range across a wavelength range comprising a plurality of discrete wavelengths. The tunable laser source scans across the wavelength range, and an interferometer directs the laser light along a sample path that interacts with a sample and a reference path. A detector captures interference signals resulting from combination of laser light returned from the reference path and the sample path as the tunable laser source scans across the wavelength range. The system may have a coherence length sufficient to maintain interference of the laser light over an optical path difference corresponding to a feature of the sample having a dimension of at least one millimeter. A controller may determine a variation of the interference signals as a function of wavelength across the scan, extract an optical path difference between the reference path and the sample path based on the variation, and generate one or more metrology measurements of the sample based on the extracted optical path difference.

In some embodiments, the interferometric measurement system may include an array of tunable laser sources arranged in a one-dimensional or two-dimensional configuration. The array may simultaneously direct laser light toward a plurality of locations on a sample, and a detector array may capture interference signals at each of the plurality of locations as the array of tunable laser sources scans across the wavelength range. This configuration may enable parallel measurement across multiple sample locations, which may increase measurement throughput for applications requiring high-density sampling or large-area coverage.

The wavelength-swept interferometry approach disclosed herein may be applied to a variety of metrology and inspection applications in semiconductor packaging. For example, the system may measure bump heights, through-silicon via (TSV) depths, remaining silicon thickness, redistribution layer critical dimensions, under-bump metallization step heights, die or wafer bow or warpage, dicing groove depths, or substrate edge hump heights or trim depths. The system may also detect defects within the sample, such as cracks within a die, voids within a die, voids at bonding interfaces, or defects in through-silicon vias, based on phase changes or interferometric pattern changes in the interference signals during the scan. In some embodiments, the system may evaluate thermal properties of the sample by monitoring changes in the interference signals resulting from temperature changes within the sample, which may provide an alternative to time-domain thermoreflectance techniques for thermal characterization.

In some embodiments, the one or more processors may apply a model to the interference signals to extract signals associated with a target feature of the sample and filter signals associated with other structures of the sample. It is contemplated herein that the extended coherence length of the tunable laser source may capture interference signals from multiple interfaces of the sample simultaneously, including signals from structures that are not the target of a particular measurement. The model may be based on an expected structure of the sample, such as a layer stack, patterned features, or known sample geometry, and may enable the one or more processors to distinguish signals associated with a target feature (e.g., associated with a measurement of interest in a given application) from other features on the sample. As an illustration, the model may identify signals associated with the target feature based on expected depth and/or lateral locations of the target feature. As another illustration, the model may identify signals associated with the target feature based on expected depth and/or lateral locations of non-target structures, which may represent noise.

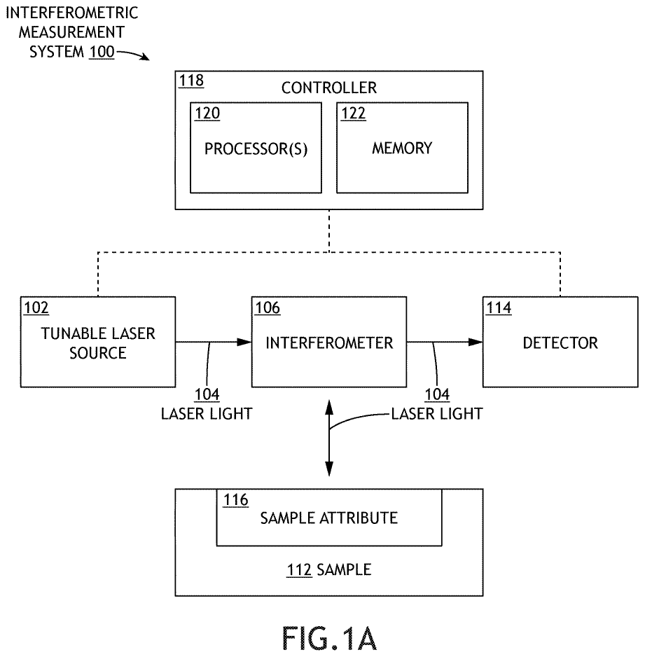

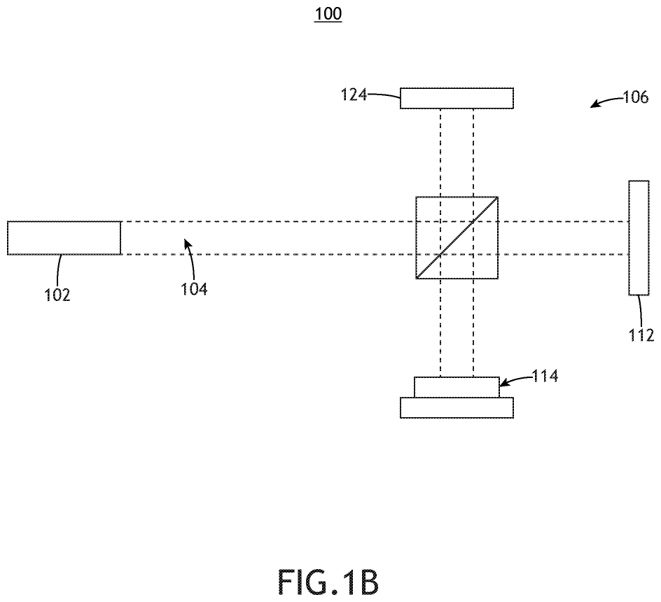

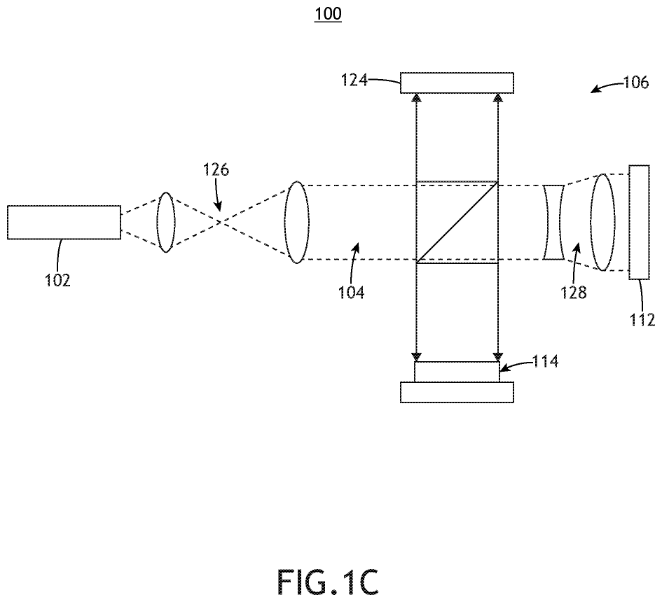

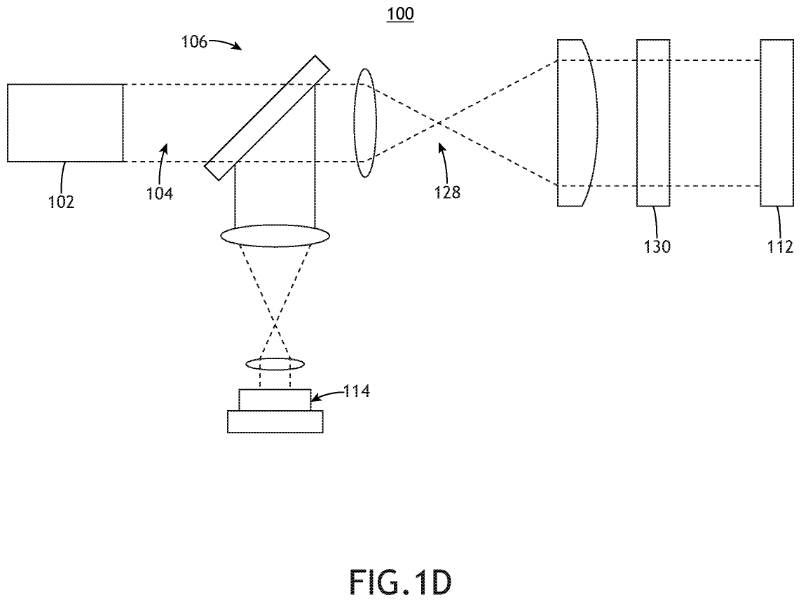

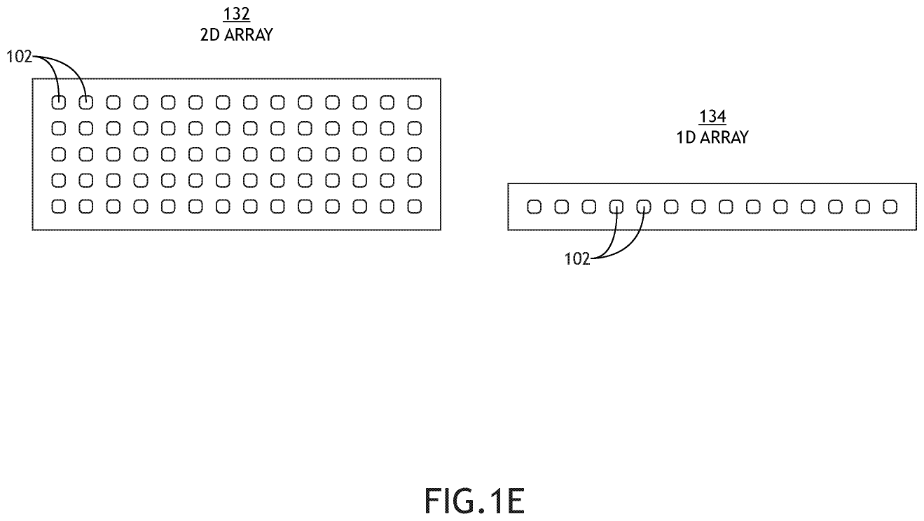

Referring now to FIGS. 1A-10, systems and methods providing long-coherence wavelength-scanning interferometry for metrology applications is described in greater detail, in accordance with one or more embodiments of the present disclosure.

FIG. 1A is a conceptual view of an interferometric measurement system 100 for performing wavelength-swept interferometry, in accordance with one or more embodiments of the present disclosure.

In embodiments, the interferometric measurement system 100 includes a tunable laser source 102 configured to emit laser light 104 and scan across a wavelength range, and an interferometer 106 that directs the laser light 104 along a sample path that interacts with a sample 112 and a reference path that interacts with a reference element. A detector 114 captures interference signals resulting from combination of the laser light 104 returned from the reference path and the sample path as the tunable laser source 102 scans across the wavelength range. The interference signals may be analyzed to determine one or more metrology measurements of a sample attribute 116 on or within the sample 112. The sample attribute 116 may represent any feature measurable via the wavelength-swept interferometry technique, including surface topography, depth-related features, thickness variations, or defects within the sample 112.

In embodiments, the interferometric measurement system 100 further includes a controller 118 communicatively coupled to the tunable laser source 102, the interferometer 106, and the detector 114. The controller 118 includes one or more processors 120 and memory 122. The one or more processors 120 may be configured to determine a variation of the interference signals as a function of wavelength across the scan, extract an optical path difference between the reference path and the sample path based on the variation, and generate one or more metrology measurements of the sample attribute 116 based on the extracted optical path difference. The one or more processors 120 may further be configured to provide a feedback signal to adjust a manufacturing process based on the metrology measurements. In some embodiments, the one or more processors 120 may apply a model to the interference signals to extract signals associated with a target feature of the sample 112 and filter signals associated with other structures of the sample 112, where the model may be based on expected depth and/or lateral locations of any combination of target features of interest and non-target features of the sample 112.

The tunable laser source 102 may include any laser source known in the art suitable for providing a continuously tunable or discretely tunable output across a wavelength range with a narrow instantaneous spectral linewidth. In some embodiments, the tunable laser source 102 may include an external cavity diode laser, a distributed feedback laser, a distributed Bragg reflector laser, a vertical-cavity surface-emitting laser (VCSEL), or a micro-electromechanical systems (MEMS) tunable laser. In some embodiments, the tunable laser source 102 may include a scanning tunable laser source (STLS) configured to sweep across the wavelength range at high speed while maintaining a narrow linewidth. The tunable laser source 102 may employ wavelength tuning mechanisms including current injection tuning, temperature tuning, mechanical tuning of an external cavity, or electro-optic tuning. In some embodiments, the tunable laser source 102 may include a semiconductor optical amplifier combined with a tunable filter element. The specific implementation of the tunable laser source 102 may be selected based on the required wavelength range, tuning speed, linewidth, output power, or cost considerations for a particular measurement application.

The tunable laser source 102 may provide laser light 104 within any wavelength range. As an illustration, the tunable laser source 102 may be configured to provide a wavelength range extending from the deep ultraviolet region to the infrared spectral range, for example from approximately 190 nm to approximately 2.0 μm. In some embodiments, the wavelength range may extend from approximately 1250 nm to approximately 1650 nm, which may provide transmission through silicon substrates for backside measurement applications.

The tunable laser source 102 may provide wavelength tuning using any technique known in the art. In some embodiments, the tunable laser source 102 may provide a broadband wavelength range comprising discrete, narrowband laser lines with small wavelength spacing, such as on the order of 0.0001 nm or smaller, enabling wavelength scanning of the sample 112 under measurement. The tunable laser source 102 may have a narrow instantaneous spectral linewidth of less than 500 MHz to as low as a few KHz at any wavelength within the tuning range. In some embodiments, the tunable laser source 102 may provide continuously-adjustable wavelengths throughout the tuning range.

The tunable laser source 102 may provide wavelength scanning at any scan rate. For example, the tunable laser source 102 may support fast scanning speeds up to 800 nm/sec or higher.

With continued reference to FIG. 1A, the narrow instantaneous spectral linewidth of the tunable laser source 102 may provide an extended coherence length sufficient to maintain interference over large optical path differences. In some embodiments, the interferometric measurement system 100 may achieve a coherence length exceeding 10,000 μm, which may be sufficient to accommodate measurement through substrates and carriers having thicknesses greater than those of standard semiconductor wafers. The extended coherence length may enable accurate measurement of depth-related features ranging from a few micrometers to hundreds of micrometers, which are commonly encountered in advanced packaging manufacturing processes. In some embodiments, the coherence length may be sufficient to maintain interference of the laser light 104 over an optical path difference corresponding to a feature of the sample 112 having a dimension of at least one millimeter.

In some embodiments, the measurement accuracy of the interferometric measurement system 100 may be better than 1 μm, with measurement repeatability and reproducibility (Gage R&R) on the order of tens of nanometers. Such performance may make the interferometric measurement system 100 suitable for monitoring and controlling advanced packaging processes involving complex multilayer structures and large topography variations.

The interferometer 106 may be configured in various arrangements, including a Michelson interferometer, a Fizeau interferometer, a Mirau interferometer, or a Linnik interferometer. The specific configuration of the interferometer 106 may be selected based on the measurement application, sample geometry, or throughput requirements. Various configurations of the interferometer 106 are described in greater detail with respect to FIGS. 1B-1D.

The detector 114 may include any sensor known in the art suitable for capturing interference signals resulting from the wavelength-swept interferometry technique. In some embodiments, the detector 114 may include a photodetector configured to capture interference signals at a single location on the sample 112. In some embodiments, the detector 114 may include a pixelated image sensor, such as a charge-coupled device (CCD) or complementary metal-oxide-semiconductor (CMOS) sensor, configured to capture a two-dimensional interference pattern as the tunable laser source 102 scans across the wavelength range. The pixelated image sensor may enable the one or more processors 120 to extract, for each pixel of the pixelated image sensor, a respective optical path difference based on the variation of the interference signals at that pixel as a function of wavelength. In some embodiments, a pixelated image sensor (e.g., a large-area sensor) may provide high-resolution measurement over a large area in a single wavelength scan.

As used throughout the present disclosure, the term “sample” generally refers to a substrate or carrier formed of a semiconductor or non-semiconductor material. For example, a semiconductor or non-semiconductor material may include, but is not limited to, monocrystalline silicon, gallium arsenide, indium phosphide, glass, ceramic materials such as alumina and aluminum nitride, fiberglass-based materials, and organic materials including FR-4, BT resin, and polyimide. The sample 112 may include one or more layers, such as a resist, a dielectric material, a conductive material, or a semiconductive material. Many different types of such layers are known in the art, and the term sample as used herein is intended to encompass a sample on which all types of such layers may be formed. One or more layers formed on the sample 112 may be patterned or unpatterned. For example, the sample 112 may include a plurality of dies, each having repeatable patterned features. The sample 112 may include semiconductor packaging structures, which may incorporate multiple semiconductor dies, complex interconnect structures, through-silicon vias, redistribution layers, bonding bumps, under-bump metallization, dielectric overcoats, interposers, and diverse materials, and which may be associated with three-dimensional stacking, heterogeneous integration, wafer-level packaging, and other advanced packaging architectures. The sample 112 may further include edge regions having trim depths or edge humps, bonding interfaces between dies or between dies and interposers, and stacked architectures suitable for thermal inspection. Many different types of devices may be formed on the sample 112, and the term sample as used herein is intended to encompass a sample on which any type of device known in the art is being fabricated. For the purposes of the present disclosure, the terms sample and wafer may be interpreted as interchangeable.

The one or more processors 120 of the controller 118 may include any processing element known in the art. In this sense, the one or more processors 120 may include any microprocessor-type device configured to execute algorithms and/or instructions. In some embodiments, the one or more processors 120 may consist of a desktop computer, mainframe computer system, workstation, image computer, parallel processor, or any other computer system (e.g., networked computer) configured to execute a program configured to operate the interferometric measurement system 100, as described throughout the present disclosure. It is further recognized that the term “processor” may be broadly defined to encompass any device having one or more processing elements, which execute program instructions from a non-transitory memory 122. Further, the steps described throughout the present disclosure may be carried out by a single controller 118 or, alternatively, multiple controllers. Additionally, the controller 118 may include one or more controllers housed in a common housing or within multiple housings. In this way, any controller or combination of controllers may be separately packaged as a module suitable for integration into the interferometric measurement system 100.

The memory 122 may include any storage medium known in the art suitable for storing program instructions executable by the associated one or more processors 120. For example, the memory 122 may include a non-transitory memory medium. By way of another example, the memory 122 may include, but is not limited to, a read-only memory, a random-access memory, a magnetic or optical memory device (e.g., disk), a magnetic tape, a solid-state drive and the like. It is further noted that memory 122 may be housed in a common controller housing with the one or more processors 120. In some embodiments, the memory 122 may be located remotely with respect to the physical location of the one or more processors 120 and controller 118. For instance, the one or more processors 120 of controller 118 may access a remote memory (e.g., server), accessible through a network (e.g., internet, intranet and the like).

In some embodiments, the functions and operations described herein may be distributed across a plurality of computing devices connected via a network, such as a local area network (LAN), wide area network (WAN), or the Internet. Certain functions may be executed locally on a client device, such as a mobile device, desktop computer, or embedded controller, while other functions may be executed remotely on one or more servers, cloud-based platforms, or edge computing nodes. The allocation of processing tasks between local and remote resources may be determined dynamically based on factors such as available computational resources, latency requirements, or data availability. Additionally, the one or more processors 120 and associated memory 122 may be used to generate and transmit control signals to one or more components of the interferometric measurement system 100, thereby directing the operation of such components in accordance with the methods described herein. The memory 122 may further be configured to store data generated by or received from the interferometric measurement system 100, including intermediate results, final outputs, sensor data, user inputs, operational parameters, and log data, such that the stored data may be retrieved for subsequent processing, analysis, display, or transmission.

Referring now to FIGS. 1B-1D, various non-limiting examples of implementation of the interferometric measurement system 100 with different interferometer configurations is described. In a general sense, the interferometric measurement system 100 may utilize any configuration of an interferometer 106.

FIG. 1B is a schematic diagram of an optical configuration of an interferometric measurement system 100 arranged as a Michelson interferometer configured for large-area measurement, in accordance with one or more embodiments of the present disclosure. In embodiments, a tunable laser source 102 emits laser light 104 as a collimated large beam that travels toward an interferometer 106. The interferometer 106 includes a beam splitter that divides the incoming laser light 104 into a reference path directed toward a reference mirror 124 and a sample path directed toward a sample 112. The reference mirror 124 reflects the laser light 104 back toward the beam splitter. The returning beams from the reference mirror 124 and the sample 112 recombine at the beam splitter, producing interference signals. A detector 114 captures the interference signals resulting from the combination of the laser light 104 returned from the reference path and the sample path as the tunable laser source 102 scans across the wavelength range.

FIG. 1C is a schematic diagram of an optical configuration of the interferometric measurement system 100 arranged as a Michelson interferometer with beam conditioning optics, in accordance with one or more embodiments of the present disclosure. In embodiments, the tunable laser source 102 emits laser light 104 as a coherent beam that passes through collimation lenses 126. The collimation lenses 126 may control a size of the illumination beam on the detector 114 and the reference mirror 124 in the interferometer 106. The sample path may further include sample-path lenses 128, which may tailor the beam size to the sample 112. In some embodiments, the detector 114 may include a high-density charge-coupled device (CCD) sensor or other pixelated image sensor that enables high-resolution measurement over a large area of the sample 112 with a single wavelength scan.

FIG. 1D is a schematic diagram of an optical configuration of the interferometric measurement system 100 arranged as a Fizeau interferometer, in accordance with one or more embodiments of the present disclosure. In embodiments, the tunable laser source 102 emits laser light 104 as a coherent beam that travels toward the interferometer 106. The interferometer 106 may include a beam splitter that directs the laser light 104 along a sample path through sample-path lenses 128, which may tailor the beam size to the sample 112. A reference flat 130 may be positioned in the sample path proximate to the sample 112. A first surface of the reference flat 130 reflects a portion of the laser light 104 back as a reference beam, while the transmitted portion continues through the reference flat 130 to the sample 112. Light reflected from the sample 112 and from the reference flat 130 recombines and travels back through the sample-path lenses 128 and the interferometer 106, producing interference signals directed to the detector 114. The detector 114 captures the resulting interference pattern for analysis as the tunable laser source 102 scans across the wavelength range.

The interferometer configurations illustrated in FIGS. 1B-1D are merely exemplary and are not intended to limit the scope of the present disclosure. The interferometric measurement system 100 may employ any interferometer configuration suitable for wavelength-swept interferometry. In some embodiments, the interferometer 106 may include a Mirau interferometer, in which a reference surface is integrated within an objective lens assembly. In some embodiments, the interferometer 106 may include a Linnik interferometer, which employs matched objectives in both the reference and sample paths. In some embodiments, the interferometer 106 may include a Mach-Zehnder interferometer or a Twyman-Green interferometer. The selection of a particular interferometer configuration may depend on factors such as the measurement application, working distance requirements, sample geometry, numerical aperture, or throughput considerations.

Referring again to the tunable laser source 102, the interferometric measurement system 100 may implement any number of tunable laser sources 102 to provide any number of beams of laser light 104 having any distribution.

In some embodiments, the interferometric measurement system 100 may employ a single tunable laser source 102 configured to provide an expanded beam of laser light 104 covering a portion of the sample 112 to be characterized. As illustrated in FIGS. 1B-1D, the laser light 104 may be expanded and collimated to illuminate a large area of the sample 112 simultaneously. In some embodiments, collimation lenses 126 or sample-path lenses 128 may condition the beam to achieve a desired illumination area on the sample 112. The detector 114 may include a pixelated image sensor configured to capture a two-dimensional interference pattern across the illuminated area as the tunable laser source 102 scans across the wavelength range, enabling parallel extraction of optical path differences at each pixel location. This configuration may provide high-resolution measurement over a large area of the sample 112 in a single wavelength scan without requiring mechanical scanning of the sample 112 or the interferometer 106.

In some embodiments, the interferometric measurement system 100 may incorporate an array of tunable laser sources to enable parallel measurement across multiple sample locations. The array configuration may increase measurement throughput for applications requiring high-density sampling or large-area coverage, and may enable control of spatial resolution through selection of beam size for each tunable laser source in the array.

FIG. 1E is a schematic diagram illustrating two configurations of an array of tunable laser sources 102, in accordance with one or more embodiments of the present disclosure.

The interferometric measurement system 100 may include any number of tunable laser sources 102 arranged in any array distribution suitable for the measurement application. FIG. 1E illustrates non-limiting examples of array configurations, including a two-dimensional (2D) array 132 comprising a grid of rows and columns and a one-dimensional (1D) array 134 comprising a single row of tunable laser sources. The array of tunable laser sources 102 may simultaneously direct laser light 104 toward a plurality of locations on the sample 112, enabling parallel acquisition of interference signals across the sample 112.

In embodiments, the detector 114 may be configured to capture interference signals at each of the plurality of locations as the array of tunable laser sources 102 scans across the wavelength range. The detector 114 may be configured to generate separate measurement signals associated with each tunable laser source of the array. In some embodiments, the detector 114 may include an array of photodetectors, such as photodiodes, with each photodetector corresponding to a respective tunable laser source of the array. In some embodiments, the detector 114 may include a pixelated image sensor, such as a charge-coupled device (CCD) or complementary metal-oxide-semiconductor (CMOS) sensor, where different portions of the pixelated image sensor provide measurements associated with different tunable laser sources of the array. The one or more processors 120 may determine, for each location, a variation of the interference signals as a function of wavelength across the scan, extract a respective optical path difference, and generate one or more metrology measurements at each of the plurality of locations based on the extracted optical path differences.

With continued reference to FIG. 1E, the beam size of each tunable laser source 102 in the array may be configured based on the measurement application. In some embodiments, the beam size may be made as small as sub-micrometer dimensions to enable process control on sub-micrometer features of the sample 112. In some embodiments, the beam size may be on the order of a few micrometers, such as approximately 3 micrometers or smaller, for measurement of features commonly encountered in advanced packaging application. In some embodiments the beam size may be on the order of approximately 1 micrometer. In some embodiments, the system may provide a resolution of approximately 2.5 micrometers or smaller. The selection of beam size may depend on factors such as the dimensions of the features to be measured, the required spatial resolution, or the throughput requirements of the measurement application.

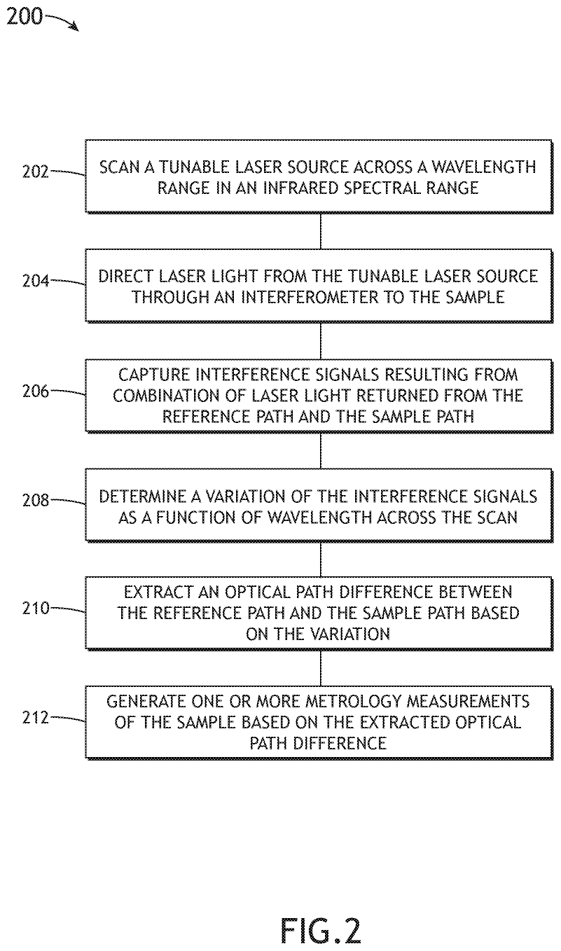

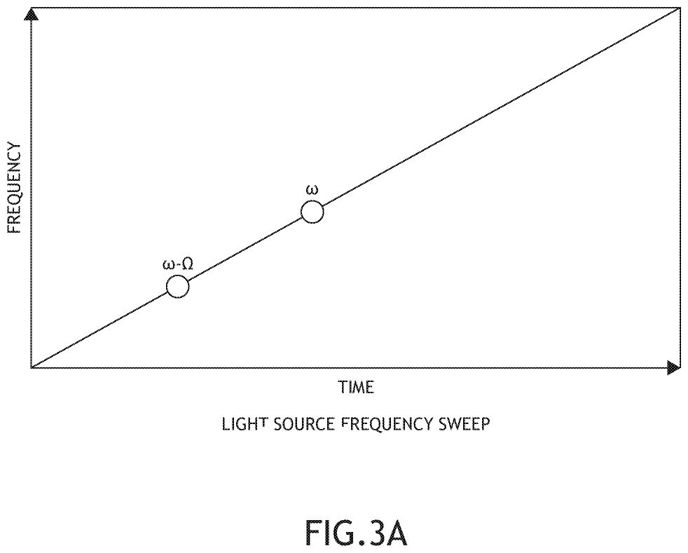

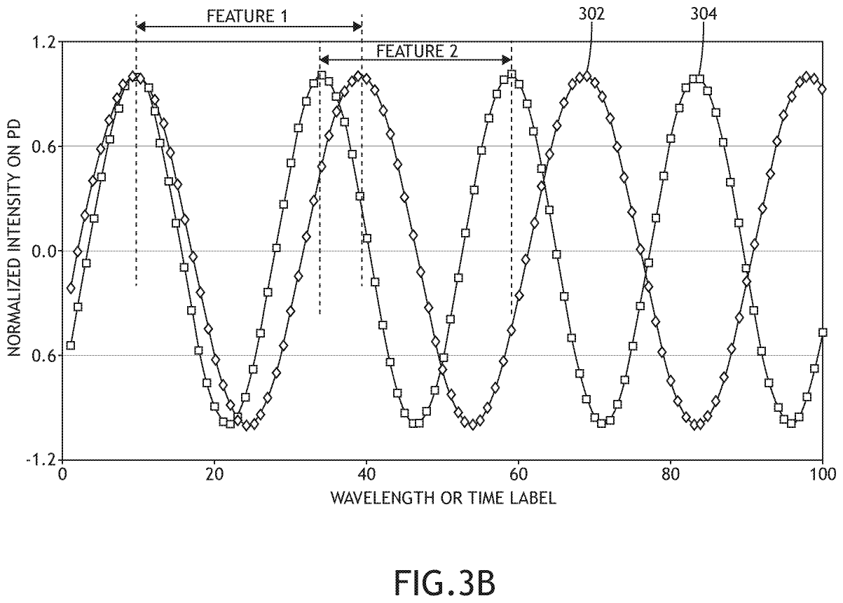

Referring now to FIGS. 2-3, a method 200 for metrology using wavelength-scanning interferometry is described, in accordance with one or more embodiments of the present disclosure. The embodiments and enabling technologies described previously herein in the context of the interferometric measurement system 100 should be interpreted to extend to the method 200. For example, the processors 120 of the controller 118 may be configured to execute program instructions stored on the memory 122, where the program instructions cause the processors 120 to perform any of the steps of the method 200 either directly or indirectly (e.g., by generating control signals to direct another component to perform an action). However, the method 200 is not limited to the architecture of the interferometric measurement system 100.

FIG. 2 is a flowchart of a method 200 for performing metrology measurements on a sample 112, in accordance with one or more embodiments of the present disclosure.

In some embodiments, the method 200 includes a step 202 of scanning a tunable laser source 102 across a wavelength range in an infrared spectral range. The wavelength range may comprise a plurality of discrete wavelengths. For example, the tunable laser source 102 may scan across a wavelength range extending from approximately 1250 nm to approximately 1650 nm. The tunable laser source 102 may have a narrow instantaneous spectral linewidth of less than 500 MHz at each wavelength within the wavelength range, providing a coherence length sufficient to maintain interference over large optical path differences. In some embodiments, the tunable laser source 102 may support fast scanning speeds up to 800 nm/sec or higher, enabling rapid acquisition of interference data across the wavelength range.

In some embodiments, the method 200 includes a step 204 of directing laser light 104 from the tunable laser source 102 through an interferometer 106 to the sample 112. The interferometer 106 may comprise a beam splitter, a reference path, and a sample path. The beam splitter may divide the incoming laser light 104 into a reference beam directed toward a reference element and a sample beam directed toward the sample 112. The interferometer 106 may be configured as a Michelson interferometer, a Fizeau interferometer, a Mirau interferometer, or a Linnik interferometer, depending on the measurement application. In some embodiments, the laser light 104 may be directed toward a backside of the sample 112 for measurement of features through a substrate of the sample 112. The infrared spectral range may provide transmission through silicon substrates, enabling measurement of features that are inaccessible to front-side measurement techniques.

In some embodiments, the method 200 includes a step 206 of capturing interference signals resulting from combination of laser light 104 returned from the reference path and the sample path as the tunable laser source 102 scans across the wavelength range. The tunable laser source 102 and the interferometer 106 may provide a coherence length sufficient to maintain interference of the laser light 104 over an optical path difference corresponding to a feature of the sample 112 having a dimension of at least one millimeter. A detector 114 may capture the interference signals, where the detector 114 may include a photodetector for single-point measurements or a pixelated image sensor for capturing two-dimensional interference patterns across a large area of the sample 112. The detector 114 may capture interference signals from multiple interfaces of the sample 112 simultaneously, including a front surface, one or more buried interfaces, and a backside surface, enabling extraction of multiple sample attributes 116 in a single wavelength scan.

In some embodiments, the method 200 includes a step 208 of determining a variation of the interference signals as a function of wavelength across the scan. As the tunable laser source 102 sweeps through the wavelength range, the interference signals exhibit oscillations whose frequency depends on the optical path difference between the reference path and the sample path. The one or more processors 120 may analyze the captured interference signals to characterize the variation of intensity as a function of wavelength. In some embodiments, the one or more processors 120 may detect anomalies in the interference signals, such as unexpected phase shifts or pattern discontinuities, that may indicate the presence of defects within the sample 112.

In some embodiments, the method 200 includes a step 210 of extracting an optical path difference between the reference path and the sample path based on the variation. The one or more processors 120 may extract the optical path difference by analyzing a frequency of oscillation of the interference signals as a function of wavelength across the scan. Different features of the sample 112 at different depths may produce interference patterns with different oscillation frequencies, enabling the one or more processors 120 to distinguish and measure multiple features during a single wavelength scan. This multi-interface measurement capability may enable simultaneous characterization of features at different depths within the sample 112, such as a bump height on a front surface and a substrate thickness, without requiring separate measurement passes.

Referring now to FIGS. 3A-3B, the generation and interpretation of interference signals for metrology measurements based on wavelength-scanning interferometry is described in greater detail, in accordance with one or more embodiments of the present disclosure.

FIG. 3A is a plot depicting a light source frequency sweep as a function of time, in accordance with one or more embodiments of the present disclosure. In particular, FIG. 3A depicts a linear wavelength sweep. However, this is merely an illustration and the wavelength may sweep with any constant or variable rate.

As described above, the step 206 of capturing interference signals may include capturing interference signals resulting from combination of laser light 104 returned from the reference path and the sample path as the tunable laser source 102 scans across the wavelength range. The tunable laser source 102 and the interferometer 106 may provide a coherence length sufficient to maintain interference of the laser light 104 over an optical path difference corresponding to a feature of the sample 112 having a dimension of at least one millimeter. The detector 114 may capture the interference signals throughout the wavelength scan, recording intensity variations at each wavelength within the wavelength range. In some embodiments, the detector 114 may include a pixelated image sensor that captures a two-dimensional interference pattern at each wavelength, enabling parallel acquisition of interference data across a large area of the sample 112.

In this configuration, light returned from the reference path and light returned from the sample path arrive at the detector 114 with a time delay corresponding to the optical path difference between the two paths. At any given instant during the frequency sweep, the light from the reference path may have a frequency ω, while the light from the sample path may have a frequency (ω−Ω) corresponding to an earlier point in the sweep, where Q represents the frequency change during the time delay. When these two beams combine at the detector 114, they produce an interference signal.

The intensity of the interference signal may be expressed as:

I=I₁+I₂+2\sqrt{I₁I₂} cos(φ₁−φ₂)
where I represents the total intensity at the detector 114, I₁ represents the intensity of light returned from the reference path, I₂ represents the intensity of light returned from the sample path, and φ₁ and φ2 represent the phases of the two beams. Expressing the phase difference in terms of the frequency and time parameters yields:

I=I₁+I₂+2\sqrt{I₁I₂} cos[(ω−Ω)t₁−ωt₂]
where t₁ and t₂ represent the time parameters for the sample path and reference path, respectively. Rearranging the terms:

I=I₁+I₂+2\sqrt{I₁I₂} cos[ω(t₁−t₂)−Ωt₁]

The time difference (t₁−t₂) corresponds to the optical path difference ΔL divided by the speed of light C, yielding:

$$I = {I}_{1} + {I}_{2} + 2 \sqrt{{I}_{1} {I}_{2}} cos [ ω ( \frac{Δ L}{C} ) - Ω {t}_{1} ] = {I}_{1} + {I}_{2} + 2 \sqrt{{I}_{1} {I}_{2}} cos [ 2 π ( \frac{Δ L}{λ} ) - Ω {t}_{1} ]$$

where I represents the total intensity at the detector 114, I₁ represents the intensity of light returned from the reference path, I₂ represents the intensity of light returned from the sample path, ω represents the angular frequency of the laser light 104, ΔL represents the optical path difference between the reference path and the sample path, C represents the speed of light, Ω represents the sweep rate of the tunable laser source 102, t₁ represents a time parameter, and/represents the wavelength of the laser light 104.

Accordingly, the intensity may vary as a sinusoidal function of the optical path difference ΔL divided by the wavelength λ. As the tunable laser source 102 scans across the wavelength range, the argument of the cosine function changes, producing oscillations in the detected intensity. The frequency of the oscillations in the wavelength domain are thus directly related to the optical path difference ΔL. In particular, a larger optical path difference produces a higher oscillation frequency, while a smaller optical path difference produces a lower oscillation frequency. The one or more processors 120 may analyze the captured interference signals to determine the oscillation frequency and thereby extract the optical path difference.

FIG. 3B is a plot depicting interference patterns for a wavelength sweep showing a first interference pattern 302 and a second interference pattern 304 corresponding to two different features of a sample 112, in accordance with one or more embodiments of the present disclosure. Each interference pattern shows normalized intensity at the detector 114 as a function of wavelength. In FIG. 3B, the first interference pattern 302 may correspond to a first feature at a first depth, while the second interference pattern 304 may correspond to a second feature at a second depth different from the first depth. The different oscillation frequencies of the first interference pattern 302 and the second interference pattern 304 demonstrate the impact of the different optical path differences associated with each feature. The interferometric measurement system 100 may thus distinguish and measure multiple features during a single wavelength scan based on the different oscillation frequencies exhibited by the interference patterns.

Referring again to FIG. 2, the method 200 may include a step 212 of generating one or more metrology measurements of the sample 112 based on the extracted optical path difference. The metrology measurements may include measurements of sample attributes 116 such as, but not limited to, bump heights, through-silicon via depths, remaining silicon thickness, redistribution layer critical dimensions, under-bump metallization step height, die or wafer bow or warpage, dicing groove depths, or substrate edge hump heights or trim depths. In some embodiments, the metrology measurements may include detection of defects within the sample 112 based on phase changes or interferometric pattern changes in the interference signals during the scan. In some embodiments, the one or more processors 120 may provide a feedback signal to adjust a manufacturing process based on the metrology measurements.

The method 200 may achieve measurement throughput suitable for in-line process monitoring and control applications. The measurement throughput may depend on factors such as the wavelength scanning speed of the tunable laser source 102, the wavelength range, the data acquisition rate of the detector 114, and the computational processing time for extracting optical path differences. In some embodiments, the method 200 may achieve measurement throughput on the order of approximately 0.5 seconds per site or faster. In some embodiments, the interferometric measurement system 100 may employ an array of tunable laser sources 102 to enable simultaneous measurement at multiple sites, further increasing overall measurement throughput. Detailed implementations of steps 206-212, including interference signal analysis and generation of specific metrology measurements, are described in subsequent sections.

The method 200 may enable high-speed measurement of large parts without requiring moving stages for depth scanning or sample translation. In conventional interferometry, depth information may be acquired by mechanically scanning a reference mirror or translating the sample, which may limit measurement throughput and introduce mechanical complexity. In contrast, the wavelength-swept interferometry approach disclosed herein extracts depth information from the variation of interference signals as a function of wavelength, eliminating the need for mechanical scanning to acquire depth profiles.

Further, parameters such as, but not limited to, the coherence length and the wavelength scan range of the tunable laser source 102 may be designed to facilitate a wide range of measurements (e.g., sample attributes 116) including, but not limited to, large wafer-scale or package-scale measurements or measurements through at least a portion of the sample 112. For example, the coherence length of the tunable laser source 102 may determine the maximum optical path difference over which interference can be maintained, and thus determines the maximum feature depth or substrate thickness that can be measured. As an illustration, a coherence length exceeding 10 mm may enable measurement through thick substrates or of deep features such as through-silicon vias having depths of hundreds of micrometers. As another example, the wavelength scan range may determine the depth resolution of the measurement, as the minimum resolvable depth difference is inversely proportional to the wavelength scan range. A larger wavelength scan range provides finer depth resolution, enabling discrimination between closely spaced features or interfaces. The wavelength scan speed and detector acquisition rate determine the measurement throughput, with faster scanning enabling rapid characterization of semiconductor packaging structures without sacrificing depth range or resolution. The combination of extended coherence length, broad wavelength scan range, and rapid scanning may enable characterization of features ranging from sub-micrometer to millimeter dimensions in a single measurement pass.

It is further contemplated herein that the metrology measurements generated by the method 200 may be used for process control in semiconductor packaging manufacturing. The interferometric measurement system 100 may support both feedback control and feedforward control approaches, depending on the manufacturing process and the sample attributes 116 being measured.

In some embodiments, the method 200 may support feedback control, in which the metrology measurements from one or more processed samples are used to adjust process parameters for subsequent samples. For example, measurements of bump height or through-silicon via depth from a first sample may be used to adjust deposition or etching parameters for subsequent samples in a manufacturing lot. The feedback control approach may reduce process drift and maintain sample attributes 116 within specified tolerances over time.

In some embodiments, the method 200 may support feedforward control, in which the metrology measurements from a sample are used to adjust process parameters for subsequent processing steps on the same sample. For example, measurements of substrate thickness or surface profile from a sample may be used to adjust parameters for a subsequent lithography, etching, or polishing step performed on that sample. The feedforward control approach may compensate for sample-to-sample variations and improve process uniformity.

In some embodiments, the one or more processors 120 may directly control one or more process tools based on the metrology measurements. In some embodiments, the one or more processors 120 may generate correctables based on the metrology measurements, where the correctables may be provided to a separate control system that implements a control loop for one or more process tools. The correctables may include adjustments to process parameters, offsets, or compensation values that the separate control system may apply to maintain process performance.

The metrology measurements may be used to control any process tool in a semiconductor packaging manufacturing flow. Examples of process tools that may be controlled based on the metrology measurements include, but are not limited to, lithography tools such as scanners or steppers, etching tools, polishing tools such as chemical-mechanical planarization tools, deposition tools, plating tools, bonding tools, dicing tools, and grinding tools. The specific process tool or tools controlled based on the metrology measurements may depend on the sample attributes 116 being measured and the manufacturing process being monitored.

In some embodiments, the step 210 of extracting an optical path difference may include analyzing a frequency of oscillation of the interference signals as a function of wavelength across the scan. The one or more processors 120 may apply frequency analysis techniques, such as Fourier transform analysis, to the interference signals to identify the oscillation frequencies present in the data. Each oscillation frequency may correspond to a respective optical path difference associated with a feature of the sample 112. In some embodiments, the one or more processors 120 may extract multiple optical path differences from a single wavelength scan when the sample 112 includes multiple features at different depths, as illustrated by the first interference pattern 302 and the second interference pattern 304 in FIG. 3B. The multi-interface measurement capability may enable simultaneous characterization of features at different depths within the sample 112 without requiring separate measurement passes.

In some embodiments, the step 212 of generating one or more metrology measurements may include converting the extracted optical path difference into dimensional measurements of sample attributes 116. The one or more processors 120 may calculate feature dimensions based on the optical path difference and the refractive index of the material through which the laser light 104 propagates. The metrology measurements may include measurements of sample attributes 116 such as bump heights, through-silicon via depths, remaining silicon thickness, redistribution layer critical dimensions, under-bump metallization step heights, die or wafer bow or warpage, dicing groove depths, or substrate edge hump heights or trim depths. In some embodiments, the metrology measurements may include detection of defects within the sample 112 based on phase changes or interferometric pattern changes in the interference signals during the scan.

In some embodiments, the method 200 may include applying a model to the interference signals to extract signals associated with a target feature of the sample 112 and filter signals associated with other structures of the sample 112. It is contemplated herein that the extended coherence length of the tunable laser source 102 may result in the detection of interference signals from multiple interfaces of the sample 112 simultaneously, which may include signals from structures that are not the target of a particular measurement application. For example, when performing backside measurements through a substrate, the interference signals may include contributions from complex patterned features on a front side of the sample 112 that may represent noise for a measurement of a backside or volumetric feature. The model may thus enable the one or more processors 120 to identify signals associated with the target feature and filter out signals associated with other features that may be considered noise in a particular measurement.

The model may incorporate any data or measurements suitable for extracting a measurement of particular target features of interest in a particular application from sources of noise in that particular application. For example, the model may incorporate design information regarding fabricated features (e.g., ideally fabricated features) on the sample 112 including, but not limited to, location information, composition information, refractive index information, or reflectivity information of fabricated features on various layers or locations of the sample 112. Put another way, this design information may provide expected depth and/or lateral information of expected features.

In some embodiments, the target feature may correspond to an expected feature of the sample 112, such as a bump, a through-silicon via, or an interface at a known location, where the model identifies signals associated with the expected feature based on expected depth and/or lateral locations derived from design information. In some embodiments, the target feature may correspond to a defect, which may include a variation of an expected feature or an erroneous or unexpected feature. A variation of an expected feature may include, for example, a bump with an incorrect height or a through-silicon via with an incorrect depth, where the model may compare measured values to expected values and identify deviations indicative of the defect. An erroneous or unexpected feature may include, for example, a void, a crack, or a delamination that should not be present in the sample 112, where the model may identify signals at locations where no features are expected or identify anomalous signal characteristics that deviate from expected patterns associated with the sample structure.

In some embodiments, any type of model suitable for extracting signals associated with target features and filtering signals associated with non-target structures may be used. In some embodiments, the model may include filtering based on design information, where the one or more processors 120 may apply spatial or frequency-domain filters to the interference signals based on expected depth and/or lateral locations of target features and non-target structures derived from design data associated with the sample 112. In some embodiments, the model may include fitting or regression approaches, where the one or more processors 120 may fit the interference signals to parametric models describing expected depth and/or lateral distributions of features, and extract target feature signals based on the fitted parameters. In some embodiments, the model may include other analytical techniques such as peak detection, windowing, or spectral analysis based on expected characteristics of target features.

In some embodiments, the model may include machine learning approaches, such as supervised learning, neural networks, or deep learning models, trained to identify signals associated with target features and filter signals associated with non-target structures. Training data for such machine learning models may include, but is not limited to, labeled interference signal data with known target feature locations and known non-target structure locations. The training data may be obtained from samples with known structures, simulation of expected interference patterns based on design information, or a combination of measured and simulated data. The trained model may thus learn to identify patterns in the interference signals that correspond to target features versus non-target structures based on the training data.

In some embodiments, the model may be tailored or configured for a particular measurement application or sample type. Different measurement applications may have different target features of interest and different sources of noise from non-target structures. For example, topside measurements, backside measurements, through-substrate measurements, defect detection, and thermal measurements may each benefit from models configured for the specific characteristics of the target features and non-target structures encountered in those applications. The model parameters, filtering characteristics, or training data may be selected or adjusted based on the specific measurement application to optimize extraction of signals associated with the target features while filtering signals associated with non-target structures.

In some embodiments, the one or more processors 120 may provide a feedback signal to adjust a manufacturing process based on the metrology measurements. The feedback signal may be provided to a process tool, such as a lithography tool, an etching tool, a polishing tool, a deposition tool, a plating tool, a bonding tool, a dicing tool, or a grinding tool, to adjust process parameters for subsequent samples or subsequent processing steps on the same sample. The interferometric measurement system 100 may support integrated metrology for in-line process monitoring and control, enabling real-time or near-real-time adjustment of process conditions based on the metrology measurements. In some embodiments, the measurement throughput may be on the order of approximately 0.5 seconds per site or faster, enabling high-throughput characterization of semiconductor packaging structures during manufacturing.

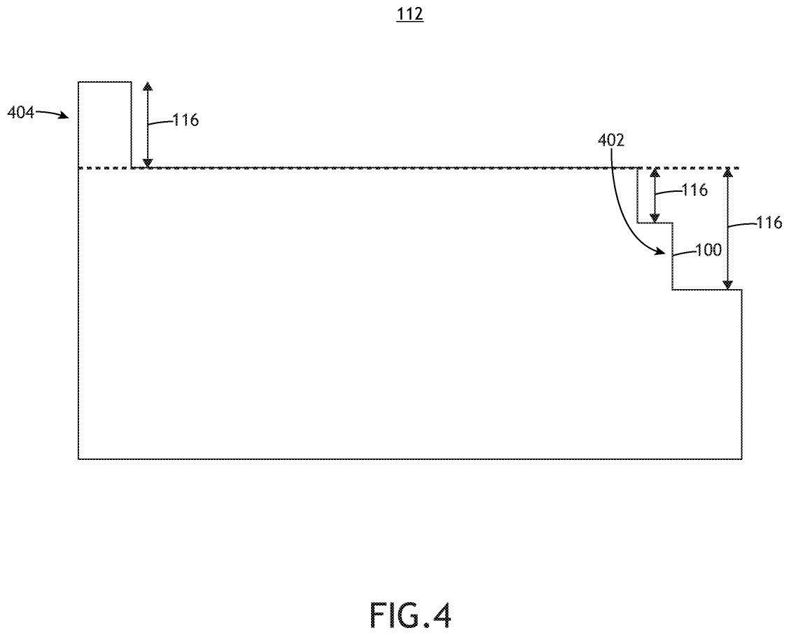

Referring now to FIGS. 4-10, non-limiting examples of measurements provided by the systems and methods disclosed herein are described, in accordance with one or more embodiments of the present disclosure.

The interferometric measurement system 100 and method 200 disclosed herein may enable a variety of measurement configurations depending on the sample attributes 116 to be characterized. In some embodiments, the laser light 104 may be directed toward a front side of the sample 112 for topside measurements of surface features such as bump heights, step heights, or surface profiles. In some embodiments, the laser light 104 may propagate into or through the sample 112 for volumetric measurements of features within the sample 112, such as buried interfaces, voids, or defects. In some embodiments, the laser light 104 may be directed toward a backside of the sample 112 for through-substrate measurements of features that are inaccessible from the front side, such as through-silicon via depths or bottom critical dimensions. The extended coherence length of the tunable laser source 102 may enable measurement through thick substrates, and the infrared spectral range may provide transmission through silicon and other semiconductor materials. The following sections describe non-limiting examples of measurements in each of these configurations.

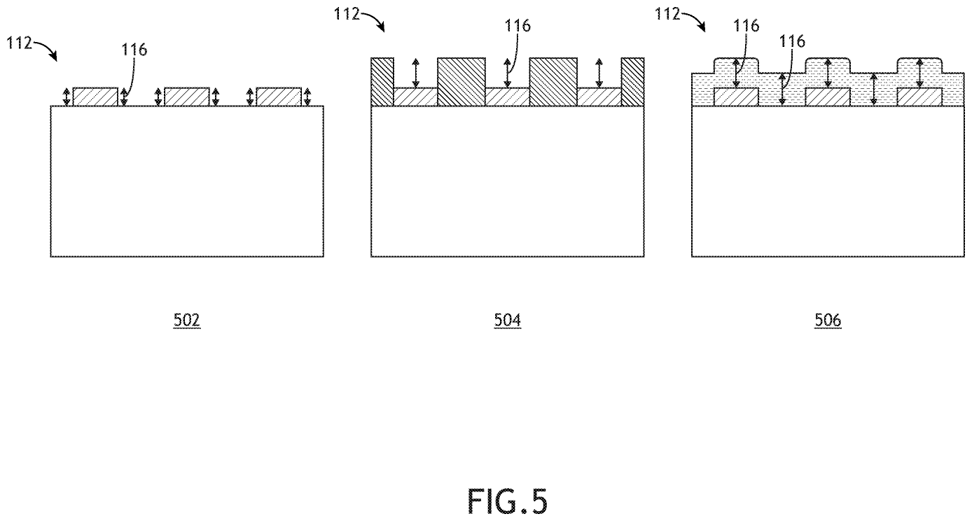

FIGS. 4-5 illustrate non-limiting examples of topside measurements. In topside measurement configurations, the laser light 104 may be directed toward a front side of the sample 112 to characterize surface features having vertical dimensions ranging from sub-micrometer to hundreds of micrometers. The extended coherence length of the tunable laser source 102 may enable measurement of relatively large topside features, such as edge humps, trim depths, or bonding bumps, that may exceed the measurement range of conventional interferometric techniques. Further, the wavelength-swept interferometry approach may acquire depth information across the full range of feature dimensions in a single wavelength scan without requiring mechanical scanning of the reference path.

FIG. 4 is a cross-sectional view of a sample 112 depicting edge feature measurements, in accordance with one or more embodiments of the present disclosure. In FIG. 4, the sample attribute 116 depicted include surface height variations across the sample 112. For example, a trim depth 402 is shown as a vertical distance from a reference plane down to a lower surface of the substrate body. As another example, an edge hump height 404 is shown as a height of a raised portion extending above the reference plane. FIG. 5 is a cross-sectional view of a sample 112 depicting topside measurements of sample attributes 116 in a semiconductor packaging process, in accordance with one or more embodiments of the present disclosure. In FIG. 5, a panel 502 shows a bonding bump height measurement, a panel 504 shows a plating delta height control measurement, and a panel 506 shows a dielectric overcoat height measurement before chemical-mechanical planarization (CMP). Other non-limiting measurements include bump coplanarity across a plurality of bumps on the sample 112, die-to-wafer stand-off height, and microbump heights. For instance, bump coplanarity may be measured by extracting optical path differences at multiple bump locations across the sample 112 and comparing the extracted heights to determine height variations across the plurality of bumps.

The extended coherence length of the interferometric measurement system 100 may enable accurate measurement of sample attributes 116 having vertical dimensions that may exceed the measurement range of conventional interferometric techniques. For example, the trim depth 402 and the edge hump height 404 illustrated in FIG. 4 may have dimensions in the range of approximately 10 to 100 micrometers or greater. Similarly, the bonding bump heights, plating delta heights, and dielectric overcoat heights illustrated in FIG. 5 may have dimensions ranging from a few micrometers to tens of micrometers. The tunable laser source 102 may provide a coherence length sufficient to maintain interference over optical path differences corresponding to these features, enabling characterization of surface topography across a wide range of feature dimensions in a single wavelength scan. In some embodiments, conventional interferometry performance may be degraded for surfaces with multiple film stacks and pattern structures, and the wavelength-swept interferometry approach disclosed herein may address this limitation by maintaining coherence through transparent film stacks. The one or more processors 120 may extract the sample attributes 116 from the interference signals by analyzing the variation of the interference signals as a function of wavelength. In some embodiments, the one or more processors 120 may apply a model to extract signals associated with target surface features, such as bonding bumps or dielectric overcoats, while filtering signals from underlying layers, redistribution layers, or substrate interfaces. In some embodiments, the interferometric measurement system 100 may achieve measurement repeatability and reproducibility of less than 20 nanometers for bump height measurements, which may be suitable for process control applications requiring high-precision measurement of bump heights, step heights, or surface profiles.

For topside measurements such as those illustrated in FIGS. 4 and 5, target features may include, but are not limited to, bonding bumps, plating delta heights, dielectric overcoat heights, bump coplanarity across a plurality of bumps, microbump heights, edge hump heights, and trim depths. Noise sources for such measurements may include, but are not limited to, signals from underlying redistribution layers, under-bump metallization interfaces, substrate interfaces, transparent film stacks, and pattern structures on underlying layers. In some embodiments, the model may use design information that provides expected bump locations in the lateral dimension and expected heights in the depth dimension. For example, the model may filter signals from known underlying layer interfaces based on expected layer stack depths derived from design data. For bump coplanarity measurements, the model may account for variations in underlying layer thickness across the sample 112 to isolate height variations attributable to the bumps themselves. In some embodiments, machine learning approaches may be trained on samples with known bump heights and known underlying layer structures to distinguish bump signals from underlying layer signals.

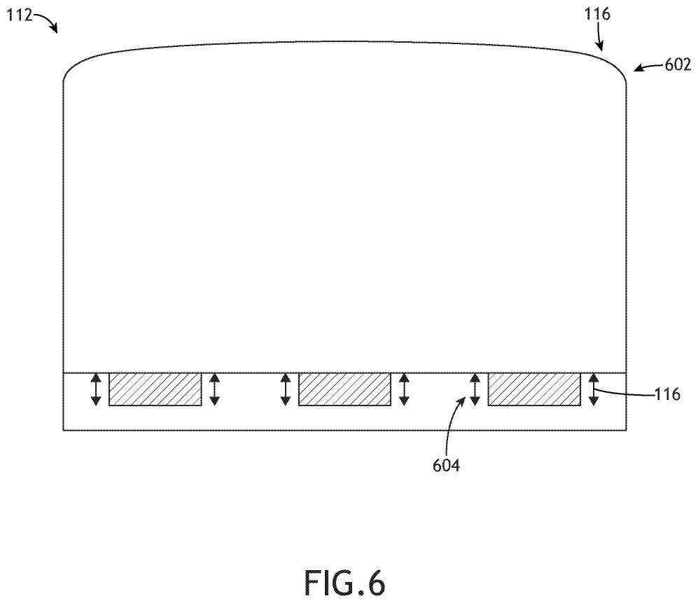

FIG. 6 is a cross-sectional view of a sample 112 depicting backside measurements of sample attributes 116, in accordance with one or more embodiments of the present disclosure. In FIG. 6, a profile measurement 602 may include topography, edge rolloff, bow, warpage, and similar surface characteristics of an underside of the sample 112, such as a backside surface opposite patterned features on a front side of the sample 112. A feature height 604 may indicate measurable vertical dimensions of structures on an opposite side of the sample 112 from the profile measurement 602. The interferometric measurement system 100 may characterize both the profile measurement 602 and the feature height 604 on opposite sides of a sample 112 in a single wavelength scan by analyzing interference signals from multiple interfaces of the sample 112 without requiring repositioning or separate measurement passes. In some embodiments, the one or more processors 120 may apply a model to filter signals from front-side patterned features when measuring backside profiles, enabling isolation of the backside surface characteristics from signals associated with internal interfaces or front-side structures.

For backside profile measurements such as those illustrated in FIG. 6, target features may include, but are not limited to, backside surface topography, edge rolloff characteristics, bow, and warpage. Noise sources for such measurements may include, but are not limited to, signals from front-side patterned features such as bumps, traces, and vias, as well as internal layer interfaces and buried structures within the sample 112. In some embodiments, the model may use design information that provides expected front-side feature locations and depths, enabling the one or more processors 120 to identify and filter signals at depths corresponding to front-side structures. For bow and warpage measurements, the model may isolate the backside surface signal from internal reflections by using expected layer stack information to distinguish between the backside surface and internal interfaces. In some embodiments, the model may account for expected variations in front-side feature density across the sample 112 to improve filtering of front-side contributions when measuring backside profiles.

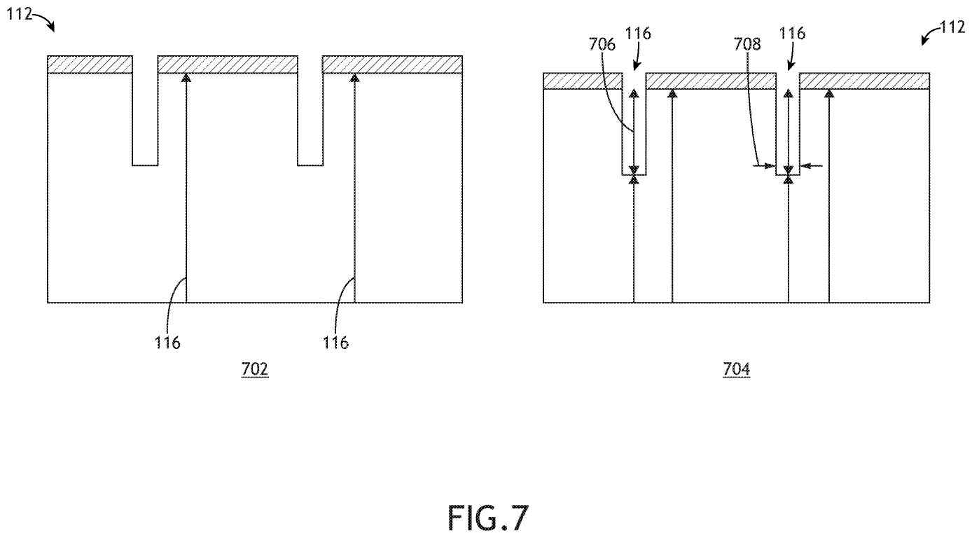

FIG. 7 is a cross-sectional view of a sample 112 depicting through-sample backside measurements of sample attributes 116, in accordance with one or more embodiments of the present disclosure. In FIG. 7, a panel 702 shows wafer thickness measurements, which are common in wafer thinning and other applications. For example, the interferometric measurement system 100 may measure remaining silicon thickness by directing laser light 104 toward a backside of the sample 112 and analyzing interference signals from a front surface and a back surface of the substrate. A panel 704 shows TSV measurements including a TSV depth 706 and a bottom critical dimension 708. The TSV depth 706 may indicate a vertical distance from a reference surface to a bottom of the through-silicon via, while the bottom critical dimension 708 may indicate a lateral dimension at the bottom of the through-silicon via.

In some embodiments, the interferometric measurement system 100 may be integrated into a processing tool for in-situ measurements during wafer backside thinning, enabling real-time thickness control. The integrated metrology capability may provide feedback to the processing tool to adjust thinning parameters based on the measured remaining silicon thickness, thereby improving process uniformity and reducing the need for separate offline metrology steps.

The extended coherence length of the interferometric measurement system 100 may enable measurement through substrates having a thickness of at least one millimeter, though smaller thicknesses may also be measured. The tunable laser source 102 operating in the infrared spectral range may provide transmission through silicon substrates, enabling characterization of features that are inaccessible to front-side measurement techniques. The interferometric measurement system 100 may measure features with depth ranging from a few micrometers to hundreds of micrometers, including high aspect ratio deep etch bottom metrology. In some embodiments, TSV depth and bottom critical dimension measurements may be performed from the backside of the sample 112 when the critical dimension of the through-silicon via is less than approximately 2 micrometers, where front-side interferometry or scatterometry techniques may face limitations. In some embodiments, when a bottom surface of a through-silicon via is not flat, the one or more processors 120 may apply averaging techniques across the bottom surface to determine an average depth measurement. The one or more processors 120 may extract the TSV depth 706 and the bottom critical dimension 708 from the interference signals by analyzing the variation of the interference signals as a function of wavelength across the scan. In some embodiments, the one or more processors 120 may apply a model to filter signals from front-side patterned features when measuring TSV depth or wafer thickness from the backside, enabling extraction of the target measurement from interference signals that may include contributions from complex front-side structures.

For through-sample backside measurements such as those illustrated in FIG. 7, target features may include, but are not limited to, TSV depth, TSV bottom critical dimension, remaining silicon thickness, and wafer thickness. Noise sources for such measurements may include, but are not limited to, signals from front-side patterned features such as bumps, redistribution layer traces, and metal patterns, as well as multiple internal layer interfaces and front-side topography variations. The model may use design information that provides expected TSV locations in the lateral dimension and expected depths, enabling the one or more processors 120 to identify TSV-related signals and filter signals from front-side patterned features based on known front-side structure locations. For wafer thickness measurements, the model may distinguish front and back surface signals from internal layer interfaces by using expected layer stack information. In some embodiments, the model may be combined with averaging techniques for non-flat TSV bottoms, where the model first filters front-side contributions and then averaging is applied across the TSV bottom region to determine an average depth measurement.

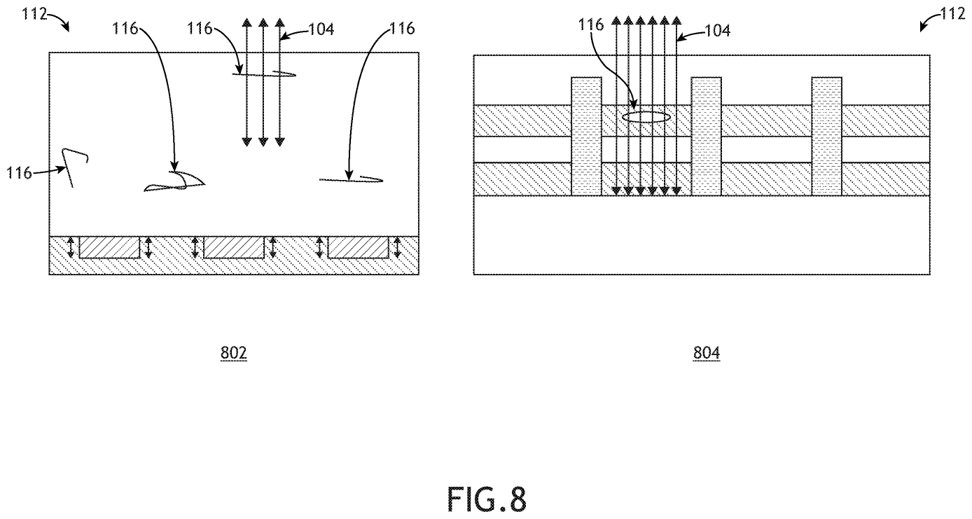

FIG. 8 is a cross-sectional view of a sample 112 depicting defect detection using laser light 104, in accordance with one or more embodiments of the present disclosure. In FIG. 8, a panel 802 depicts backside detection of defects within the sample 112, such as cracks or damage resulting from dicing operations. A panel 804 depicts dielectric void detection within the sample 112, including voids between bonding die and wafers. The interferometric measurement system 100 may detect such defects by directing laser light 104 toward the sample 112 and analyzing the interference signals captured by the detector 114 as the tunable laser source 102 scans across the wavelength range. Arrows in FIG. 8 indicate incident laser light 104 and the locations of detected sample attributes 116.

In embodiments, defects within the sample 112 may result in phase changes and interferometric pattern behavior changes during the wavelength scan. The one or more processors 120 may detect anomalies in the interference signals, such as unexpected phase shifts or pattern discontinuities, that indicate the presence of defects. The infrared spectral range of the tunable laser source 102 may provide transmission through silicon, enabling detection of defects that are inaccessible to visible-wavelength inspection techniques. In some embodiments, the interferometric measurement system 100 may perform backside inspection through metal films for dicing edge defect detection, where the infrared wavelength may provide penetration to the metal level for such inspection. In some embodiments, the interferometric measurement system 100 may detect voids having thicknesses on the order of tens of nanometers or smaller based on the sensitivity of the phase change detection. In some embodiments, the one or more processors 120 may apply a model based on an expected structure of the sample 112 to distinguish defect signatures from normal interface signals, enabling identification of anomalous signals that indicate the presence of defects.

For defect detection such as that illustrated in FIG. 8, target features may include, but are not limited to, defects such as cracks within a die, voids within a die, voids at bonding interfaces, delaminations, and dicing damage. Unlike measurements of expected structural features, defect detection targets features that represent variations from expected structures or erroneous features that should not be present. Noise sources for defect detection may include, but are not limited to, normal interface signals from expected structural features and layer boundaries that are part of the intended sample design. The model may use design information that provides the expected structure of the sample 112, enabling the one or more processors 120 to identify signals at locations where no features are expected, which may indicate erroneous features such as voids or cracks. The model may also compare measured signals to expected patterns and identify anomalies such as unexpected phase shifts or pattern discontinuities that deviate from expected behavior. In some embodiments, machine learning approaches may be trained on samples with known defects and samples with known good structures to learn patterns in the interference signals that distinguish defect signatures from normal structural signals. The sensitivity of the phase change detection may enable detection of thin voids, where the model may identify subtle deviations from expected phase behavior indicative of such defects.

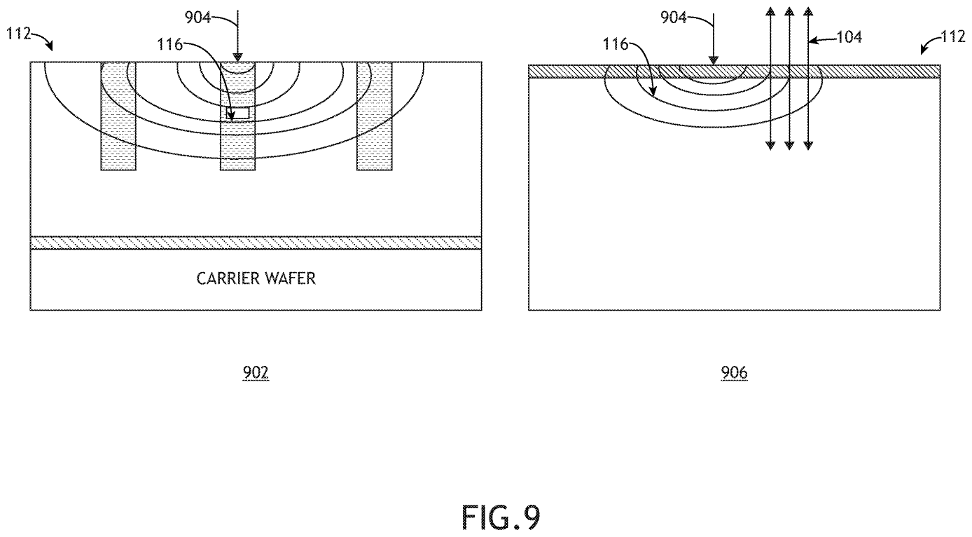

FIG. 9 is a cross-sectional view of a sample 112 depicting thermal-based measurements using pump light 904 and laser light 104, in accordance with one or more embodiments of the present disclosure. In FIG. 9, pump light 904 may heat the sample 112, and laser light 104 associated with the interferometer 106 may probe refractive index variations induced by the heating. The pump light 904 may have any characteristics suitable for heating the sample 112 and may include coherent laser light, incoherent light, continuous-wave light, or pulsed light having any suitable pulse duration, repetition rate, or energy. A panel 902 depicts void detection in metal-filled through-silicon vias (TSVs), where voids within the metal fill may alter the local thermal response and produce detectable changes in the interference signals captured by the detector 114. A panel 906 depicts temperature or thermal conductivity measurements, which may provide an alternative to time-domain thermoreflectance (TDTR) techniques for thermal characterization of the sample 112.

As shown in FIG. 9, the refractive index of silicon may exhibit sensitivity to temperature change, with a temperature coefficient of refractive index (dn/dT) of approximately 1.9×10⁻⁴ per degree Celsius. The interferometric measurement system 100 may detect temperature-induced refractive index changes within the sample 112 by monitoring variations in the interference signals as the pump light 904 heats the sample 112. In some embodiments, the interferometric measurement system 100 may perform thermal interface material film characterization and thermal conductivity measurement by analyzing the thermal response of the sample 112 to heating by the pump light 904. The one or more processors 120 may evaluate thermal properties of the sample 112 by monitoring changes in the interference signals resulting from temperature changes within the sample 112, enabling characterization of thermal diffusion efficiency at bonding interfaces, detection of voids in metal-filled structures based on altered thermal response, and measurement of thin film thermal conductivity. In some embodiments, the one or more processors 120 may apply a model to extract thermal-induced refractive index changes from baseline structural signals, separating temperature-dependent signal variations from static structural contributions to isolate the thermal response of the sample 112.

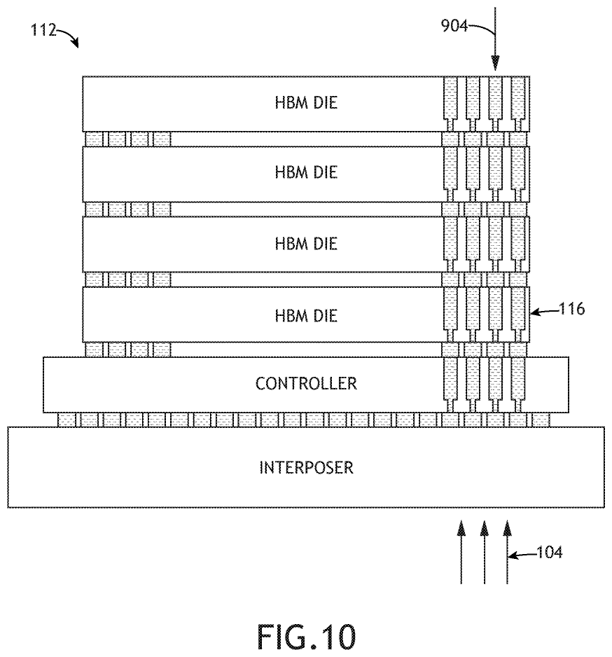

For thermal measurements such as those illustrated in FIGS. 9 and 10, target features may include, but are not limited to, temperature-induced refractive index changes, thermal diffusion efficiency variations at bonding interfaces, void detection based on altered thermal response, and thermal conductivity characteristics. Noise sources for such measurements may include, but are not limited to, static structural signals from layer interfaces and features, baseline interference patterns unrelated to thermal effects, and reflections from interfaces that do not change with temperature. The model may establish a baseline structural model that captures the expected interference pattern without thermal excitation, enabling the one or more processors 120 to separate temperature-dependent signal variations from static structural contributions. For void detection in metal-filled TSVs, the model may identify altered thermal response compared to expected thermal diffusion characteristics in properly filled vias, where voids may cause localized changes in thermal conductivity that produce detectable deviations from expected thermal behavior. In some embodiments, time-resolved measurements may require the model to track thermal transients, where the model may compare the temporal evolution of the interference signals to expected thermal diffusion characteristics based on material properties and sample geometry.

FIG. 10 is a cross-sectional view of a stacked semiconductor packaging architecture of a sample 112 suitable for thermal inspection using pump light 904 and laser light 104, in accordance with one or more embodiments of the present disclosure. In FIG. 10, the sample 112 may include a stack comprising multiple die layers, a controller layer, and an interposer layer interconnected by through-silicon vias. The interferometric measurement system 100 may perform packaging thermal inspection for defects and thermal diffusion efficiency at bonding interfaces between elements of the stack, such as between dies, between a die and a controller, or between a controller and an interposer. In some embodiments, the interferometric measurement system 100 may perform high-bandwidth memory (HBM) inspection after bonding of each core die, after logic die bonding, and after interposer bonding. The pump light 904 may heat the sample 112 at a bonding interface or other region of interest, and the laser light 104 may probe refractive index variations induced by the heating to characterize thermal properties and detect defects at the bonding interface. In some embodiments, the interferometric measurement system 100 may perform real-time wafer temperature monitoring in a processing chamber by detecting temperature-induced refractive index changes within the sample 112. As indicated by arrows in FIG. 10, the interferometric measurement system 100 may perform measurements from a frontside direction or a backside direction for characterizing sample attributes 116 including bonding integrity, void detection, and thermal properties within the stacked structure.

The measurement configurations and sample attributes 116 illustrated in FIGS. 4-10 and described herein are merely exemplary and are not intended to limit the scope of the present disclosure. The interferometric measurement system 100 and method 200 may be applied to any measurement application in which wavelength-swept interferometry may provide characterization of sample attributes 116 on a surface of a sample 112, within a sample 112, or through a sample 112. The specific sample attributes 116, feature dimensions, measurement configurations, and applications described herein are provided as non-limiting illustrations of the capabilities of the systems and methods disclosed herein. One skilled in the art will recognize that the interferometric measurement system 100 and method 200 may be adapted to measure other sample attributes 116 not explicitly described herein, and that the principles disclosed herein may be applied to other industries and applications beyond semiconductor packaging.

All of the methods described herein may include storing results of one or more steps of the method embodiments in memory. The results may include any of the results described herein and may be stored in any manner known in the art. The memory may include any memory described herein or any other suitable storage medium known in the art. After the results have been stored, the results can be accessed in the memory and used by any of the method or system embodiments described herein, formatted for display to a user, used by another software module, method, or system, and the like. Furthermore, the results may be stored “permanently,” “semi-permanently,” temporarily,” or for some period of time. For example, the memory may be random-access memory (RAM), and the results may not necessarily persist indefinitely in the memory.

It is further contemplated that each of the embodiments of the method described above may include any other step(s) of any other method(s) described herein. In addition, each of the embodiments of the method described above may be performed by any of the systems described herein.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mateable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. An interferometric measurement system comprising:
a tunable laser source configured to emit laser light in an infrared spectral range across a wavelength range comprising a plurality of discrete wavelengths, the tunable laser source configured to scan across the wavelength range;
an interferometer including a sample path and a reference path, wherein the laser light in the sample path interacts with a sample;
a detector configured to capture interference signals resulting from combination of the laser light returned from the reference path and the sample path as the tunable laser source scans across the wavelength range; and
a controller including one or more processors configured to execute program instructions causing the one or more processors to:
determine a variation of the interference signals as a function of wavelength across the scan;
extract an optical path difference between the reference path and the sample path based on the variation; and
generate one or more metrology measurements of the sample based on the extracted optical path difference.

2. The interferometric measurement system of claim 1, wherein the one or more processors are configured to extract the optical path difference by analyzing a frequency of oscillation of the interference signals as a function of wavelength across the scan.

3. The interferometric measurement system of claim 1, wherein the one or more processors are further configured to apply a model to the interference signals to extract signals associated with a target feature of the sample and to filter signals associated with other structures of the sample, wherein the model is based on an expected structure of the sample.

4. The interferometric measurement system of claim 3, wherein the model is based on at least one of: design information associated with the sample, or other metrology measurements of the sample.

5. The interferometric measurement system of claim 3, wherein the model comprises a machine learning model trained on labeled interference signal data with known target feature locations and known non-target structure locations.

6. The interferometric measurement system of claim 1, wherein the wavelength range extends from approximately 1250 nm to approximately 1650 nm.

7. The interferometric measurement system of claim 1, wherein the tunable laser source has an instantaneous spectral linewidth of less than 500 MHz at each wavelength within the wavelength range.

8. The interferometric measurement system of claim 1, wherein the plurality of discrete wavelengths have a wavelength spacing of 0.0001 nm or smaller.

9. The interferometric measurement system of claim 1, wherein the one or more processors are further configured to provide a feedback signal to adjust a manufacturing process based on the metrology measurements.

10. The interferometric measurement system of claim 1, wherein the interferometer comprises one of: a Michelson interferometer, a Fizeau interferometer, a Mirau interferometer, or a Linnik interferometer.

11. The interferometric measurement system of claim 1, wherein the detector comprises a photodetector.

12. The interferometric measurement system of claim 1, wherein the detector comprises a pixelated image sensor configured to capture a two-dimensional interference pattern as the tunable laser source scans across the wavelength range, and wherein the one or more processors are configured to extract, for each pixel of the pixelated image sensor, a respective optical path difference based on the variation of the interference signals at that pixel as a function of wavelength.

13. The interferometric measurement system of claim 1, wherein the sample path is configured to direct laser light toward a backside of the sample for measurement of features through a substrate of the sample.

14. The interferometric measurement system of claim 1, wherein the metrology measurements comprise at least one of: a bump height, a through-silicon via depth, a remaining silicon thickness, a redistribution layer critical dimension, an under-bump metallization step height, a die or wafer bow or warpage, a dicing groove depth, or a substrate edge hump height or trim depth.

15. The interferometric measurement system of claim 1, wherein the metrology measurements comprise detection of a defect within the sample based on a phase change or interferometric pattern change in the interference signals during the scan, and wherein the defect comprises at least one of: a crack within a die, a void within a die, a void at a bonding interface, or a defect in a through-silicon via.

16. The interferometric measurement system of claim 1, wherein the sample comprises a substrate formed from at least one of: silicon, glass, a ceramic material, alumina, aluminum nitride, FR-4, BT resin, or polyimide.

17. The interferometric measurement system of claim 1, wherein a coherence length of the tunable laser source is sufficient to maintain interference of the laser light over an optical path difference of at least 1 millimeter.

18. An interferometric measurement system comprising:
an array of tunable laser sources, each tunable laser source configured to emit laser light in an infrared spectral range across a wavelength range comprising a plurality of discrete wavelengths and scan across the wavelength range, the array configured to simultaneously direct laser light toward a plurality of locations on a sample;
an interferometer comprising a beam splitter, a reference path, and a sample path;
a detector configured to capture interference signals at each of the plurality of locations as the array of tunable laser sources scans across the wavelength range, each interference signal resulting from combination of laser light returned from the reference path and the sample path; and
a controller including one or more processors configured to:
determine, for each location, a variation of the interference signals as a function of wavelength across the scan;
extract, for each location, an optical path difference between the reference path and the sample path based on the variation; and
generate one or more metrology measurements of the sample at each of the plurality of locations based on the extracted optical path differences.

19. The interferometric measurement system of claim 18, wherein the one or more processors are further configured to apply a model to the interference signals to extract signals associated with a target feature of the sample and to filter signals associated with other structures of the sample.

20. The interferometric measurement system of claim 18, wherein the array of tunable laser sources is arranged in a one-dimensional configuration.

21. The interferometric measurement system of claim 18, wherein the array of tunable laser sources is arranged in a two-dimensional configuration.

22. The interferometric measurement system of claim 18, wherein the detector comprises an array of photodetectors, each photodetector corresponding to a respective tunable laser source of the array.

23. The interferometric measurement system of claim 18, wherein the detector comprises a pixelated image sensor, and wherein the one or more processors are configured to extract, for each pixel of the pixelated image sensor, a respective optical path difference based on the variation of the interference signals at that pixel as a function of wavelength.

24. The interferometric measurement system of claim 18, wherein the sample path is configured to direct laser light toward a backside of the sample for measurement of features through a substrate of the sample.

25. The interferometric measurement system of claim 18, wherein the sample comprises a semiconductor packaging structure.

26. A method for performing metrology measurements on a sample, the method comprising:
scanning a tunable laser source across a wavelength range in an infrared spectral range, the wavelength range comprising a plurality of discrete wavelengths;
directing laser light from the tunable laser source through an interferometer to the sample, the interferometer comprising a beam splitter, a reference path, and a sample path;
capturing interference signals resulting from combination of laser light returned from the reference path and the sample path as the tunable laser source scans across the wavelength range;
determining a variation of the interference signals as a function of wavelength across the scan;
extracting an optical path difference between the reference path and the sample path based on the variation; and
generating one or more metrology measurements of the sample based on the extracted optical path difference.

27. The method of claim 26, further comprising applying a model to the interference signals to extract signals associated with a target sample attribute and filter signals associated with other structures of the sample, wherein the model is based on an expected structure of the sample.

28. The method of claim 26, wherein the metrology measurements comprise at least one of: a bump height, a through-silicon via depth, a remaining silicon thickness, a redistribution layer critical dimension, an under-bump metallization step height, a die or wafer bow or warpage, a dicing groove depth, or a substrate edge hump height or trim depth.

29. The method of claim 26, wherein the metrology measurements comprise detection of a defect within the sample based on a phase change or interferometric pattern change in the interference signals during the scan.

30. The method of claim 29, wherein the defect comprises at least one of: a crack within a die, a void within a die, a void at a bonding interface, or a defect in a through-silicon via.

31. The method of claim 26, further comprising directing the laser light toward a backside of the sample for measurement of features through a substrate of the sample.

32. The method of claim 26, wherein the tunable laser source comprises an array of tunable laser sources arranged in a one-dimensional or two-dimensional configuration, and wherein capturing the interference signals comprises capturing interference signals at a plurality of locations on the sample in parallel.

33. The method of claim 26, wherein the metrology measurements comprise evaluation of a thermal property of the sample by monitoring a change in the interference signals resulting from a temperature change within the sample.
